(19) United States
(12) Patent Application Publication
(10) Pub. No.: US 2024/0032491 A1
(43) Pub. Date: Feb. 1, 2024

(54) IRRIGATION AND PLANTING SYSTEMS, METHODS AND COMPONENTS OF IRRIGATION/PLANTING SYSTEMS

(71) Applicant: IDEM IRRIGATION, LLC, Gering, NE (US)

(72) Inventors: Jared Ross, Gering, NE (US); Brent Holliday, Gering, NE (US); Phil Holliday, Gering, NE (US); Justin Reinmuth, Gering, NE (US)

(21) Appl. No.: 18/228,390

(22) Filed: Jul. 31, 2023

Related U.S. Application Data
(60) Provisional application No. 63/393,634, filed on Jul. 29, 2022.

(51) Int. Cl. A01G 25/09

(52) U.S. Cl. CPC A01G 25/092

(57) ABSTRACT

The instant invention provides moving irrigation (such as pivot-style or linear/lateral move style) systems and method of crop irrigation, chemigation, fertigation and/or planting, and components of moving irrigation/chemigation/fertigation/planting systems. Some embodiments of the invention include unique spraying heads that attach to the end of a flexible gooseneck attached to a span.

### CROSS-REFERENCE TO RELATED APPLICATIONS

This application claims priority to U.S. Provisional Patent Application Ser. No. 63/393,634, filed Jul. 29, 2022, the entire disclosure of which is incorporated herein by reference.

### FIELD OF THE INVENTION

The present invention relates generally to crop irrigation/planting. More specifically, the present invention relates to systems and method of crop irrigation, chemigation, fertigation and/or planting, and components of irrigation/chemigation/fertigation/planting systems. Even more specifically, the present invention relates to moving irrigation (such as pivot-style or linear/lateral move style) systems and method of crop irrigation, chemigation, fertigation and/or planting, and components of moving irrigation/chemigation/fertigation/planting systems.

### BACKGROUND OF THE INVENTION

Moving irrigation systems, such as center pivots (or linear/lateral move style irrigation systems) are complex machines that are commonly used for crop irrigation. A center pivot generally comprises one or more span pipes (spans) supported on wheeled towards above the crops, and connected to a central pivot point to deliver water to the field surrounding the central pivot point via spraying heads connected to goosenecks positioned along the spans. While center pivot (and linear/lateral move) technology provides many benefits over other types of surface irrigation, the elevated location of the sprayer heads, and the non-laminar flow of water can result in significant evaporation. In addition, such systems typically are not capable of use for chemigation, fertigation and/or planting. Furthermore, moving irrigation systems are not as effective and even subject to damage in high winds.

Therefore, it is desirable to provide moving irrigation (such as pivot-style or linear/lateral move style) systems and method of crop irrigation, chemigation, fertigation and/or planting, and components of moving irrigation/chemigation/fertigation/planting systems that overcome the deficiencies and/or provide additional benefits to conventional technology.

### SUMMARY OF THE INVENTION

The instant invention provides moving irrigation (such as pivot-style or linear/lateral move style) systems and method of crop irrigation, chemigation, fertigation and/or planting, and components of moving irrigation/chemigation/fertigation/planting systems. Some embodiments of the invention include unique spraying heads that attach to the end of a gooseneck attached to a span. The spraying head of the present invention is generally ball-shaped with a hollow center that fills up with water during irrigation to add weight to the spraying head. The added weight allows the spraying head to be pulled through the crop canopy by the irrigation system and reduces deflection of the spraying head due to gusts of wind. In some embodiments the spraying head is an omni-directional spraying head. In some embodiments the spraying head is pre-drilled (or otherwise manufactured with orifices) to result in predetermined discharge parameters. In other embodiments, the spraying head is capable of being drilled by the end user to the specific discharge parameters desired by that end user.

In some embodiments of the present invention, the spraying head is used in combination with a unique gooseneck of the present invention. In other embodiments, the spraying head is used in combination with conventional goosenecks. In still other embodiments, the gooseneck of the present invention is used in combination with conventional spraying heads.

In some embodiments of the present invention, the gooseneck is structured to position a spraying head below the crop canopy. In some embodiments, the gooseneck of the present invention includes a connecting system to reduce stress on the threads going into the main pipe of the span. In some such embodiments the connecting system provides additional support of the gooseneck to the main pipe. In some such embodiments, the connecting system supports the drop and, in some embodiments, also allows the end user to move the drop to hit a specific row desired in the crops. In some embodiments, the gooseneck includes a coupling for tethering multiple goosenecks together along a span to create a stabilizing force along the span.

Some embodiments of the present invention include a roller pipe. The roller pipe allows the end user to place sprayer heads a desired heights within the field. In some embodiments the pipe is made of HDPE plastic to minimize weight and allow for on-sight repairs. In some embodiments, the roller pipe is supported by an inventive cradle-roller assembly.

Some embodiments of the present invention include a unique span main pipe that allows for irrigation, chemigation, fertigation, hydraulics and electrical through a single span. Some embodiments of the present invention include a shield attachment to help prevent deep rutting from ground saturation and the weight of the span wheels.

Some embodiments of the present invention include a bladder system that is fillable with water and connected to wheelbase of the span to help anchor the span during high winds or other similar events.

Some embodiments of the present invention include a counterweight device use to help prevent rollover of a moving irrigation system.

Some embodiments of present invention include a system to plant cover crops.

It will be appreciated that various embodiments of components and/or combinations of the present invention are capable of use in irrigation applications, as well as in chemigation, fertigation and/or planting applications.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

Preferred embodiments of the present invention, illustrative of the best mode in which the applicant has contemplated applying the principles, is set forth herein and is shown in the Exhibit A attached hereto.

### DETAILED DESCRIPTION OF THE INVENTION

As required, a detailed description of the various embodiments of the present invention are disclosed herein; however, it is to be understood that the disclosed embodiments are merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The instant invention provides moving irrigation (such as pivot-style or linear/lateral move style) systems and method of crop irrigation, chemigation, fertigation and/or planting, and components of moving irrigation/chemigation/fertigation/planting systems. In some embodiments of the present invention, the system moves linearly/laterally. In other embodiments, the system moves by pivoting around a central axis.

An exemplary embodiment of the present invention includes a main pipe 100 that is moved linearly or rotationally across a field. A plurality of gooseneck assemblies 200 (sometimes referred to as just “gooseneck”) are attached at one end to the main pipe 100. The other end of each gooseneck assembly 200 is attached to a spraying head 300. Water or another substance pass through the main pipe 100 to the goosenecks 200, and out the spraying head 300 to be delivered to the field.

Some embodiments of the present invention include a unique span main pipe 100 that allows for irrigation, chemigation, fertigation, hydraulics and electrical through a single span. Any liquid, gas, or solid substance can pass through the main pipe 100, including but not limited to water, nutrients, chemicals, seeds, herbicides, insecticides fungicides, or fertilizer. Furthermore, electrical currents can be passed through the main pipe 100. In some embodiments of the present invention, one or more of these items can pass through the main pipe 100 simultaneously.

In some embodiments of the present invention, the main pipe 100 is portioned to have a plurality of internal sections. One embodiment of the present invention includes four internal circular cross-sections adjacent to each other. This creates nine total separate internal lines of the main pipe 100—the four circular cross-sections themselves, a central curved-diamond-shaped space in-between all four of the circular cross-sections, and four curved-triangle-shaped spaces between the adjacent circular cross-sections. Some embodiments of the present invention include a differing number of internal circular cross-sections. In some embodiments, the internal cross-sections may be other shapes. In some embodiments, the internal circular cross-sections are HDPE lines. In some embodiments, these are 1¼′ HDPE lines.

In some embodiments the main pipe 100 is linear. In some embodiments, the main pipe 100 is curved. In some embodiments of the present invention the main pipe 100 has a substantially circular cross-section. It will be appreciated that other cross-sections may be used for the main pipe 100. In some embodiments, the main pipe is reinforced with various support structures. In some embodiments this includes, various frames, braces, struts, support rods, and other commonly known support structures.

In some embodiments, the main pipe 100 has a plurality of nozzles 210 spaced on top and along the span of the pipe. Each nozzle 210 has a hollow internal cross-section, wherein the liquid, gas, or other material passing through the main pipe 100 exits the main pipe 100 via the plurality of nozzles 210. The liquid, gas, or other material exiting the main pipe 100 via a nozzle 210 then enters a gooseneck 200. In some embodiments, the nozzles 210 may be on the bottom or side of the main pipe 100. In other embodiments, they may be placed in any combination thereof.

Some embodiments of the present invention include a roller pipe 110 attached below the main pipe 100 via a cradle-roller assembly 120. Any liquid, gas, or solid substance can pass through the roller pipe 110, including but not limited to water, nutrients, chemicals, seeds, herbicides, insecticides fungicides, or fertilizer. Furthermore, electrical currents can be passed through the roller pipe 110. In some embodiments of the present invention, one or more of these items can pass through the roller pipe 110 simultaneously.

In some embodiments the roller pipe 110 is in fluid communication with the main pipe 100. In some embodiments, the roller pipe 110 has no fluid communication with the main pipe and draws the liquid, gas, or other material from a different source than from where the main pipe 110 draws.

In some embodiments of the present invention, the roller pipe 110 is portioned to have a plurality of internal sections. One embodiment of the present invention includes four internal circular cross-sections adjacent to each other. This creates nine total separate internal lines of the roller pipe 110—the four circular cross-sections themselves, a central curved-diamond-shaped space in-between all four of the circular cross-sections, and four curved-triangle-shaped spaces between the adjacent circular cross-sections. Some embodiments of the present invention include a differing number of internal circular cross-sections. In some embodiments, the internal cross-sections may be other shapes. In some embodiments, the internal circular cross-sections are HDPE lines. In some embodiments, these are 1¼′ HDPE lines.

In some embodiments the roller pipe 110 is linear. In some embodiments, the roller pipe 110 is curved. In some embodiments of the present invention the roller pipe 110 has a substantially circular cross-section. It will be appreciated that other cross-sections may be used for the roller pipe 110. In some embodiments, the roller pipe 110 is reinforced with various support structures. In some embodiments this includes, various frames, braces, struts, support rods, and other commonly known support structures.

In some embodiments, the cradle-roller assembly 120 is used to attach the roller pipe 110 to the main pipe 100. The cradle-roller assembly 120 includes a plurality of cradles 122. Each cradle 122 is attached to the main pipe 100. In some embodiments, the cradles 122 are hung from the main pipe 100 via rope, chains, string, or by similar means. Each cradle 122 is capable of holding the roller pipe 110 inside the hollow center. In some embodiments, each cradle 122 includes three pairs of rollers 124 spaced out from each other. The rollers 124 engage the roller pipe 110 held inside the cradle 122 so that there are three separate points of contacts between each cradle and the roller pipe. In some embodiments, additional rollers are used. In some other embodiments, no rollers are used and the roller pipe 110 is contained within the walls of the cradle 122 only.

The roller pipe 110 allows the end user to place sprayer heads a desired heights within the field because the cradles 122 of the cradle-roller assembly 120 may be easily adjusted in reference to the main pipe 100. This is done by adjusting the length of the rope, chain, string, or other device used to attach the cradles 122 to the main pipe 100 thereby lowering or raising the height of the roller pipe 110.

In some embodiments, the roller pipe 110 has a plurality of nozzles 210 spaced on top and along the span of the pipe. Each nozzle 210 on the roller pipe 110 functions similar to those on the main pipe 100. In some embodiments, the nozzles 210 may be on the bottom or side of the roller pipe 110. In other embodiments, they may be placed in any combination thereof. In some embodiments, the gooseneck 200 attachments may be welded to the roller pipe 110.

The main pipe 100 is attached to one or more wheel assemblies 130. In some pivot-style embodiments, one end of the main pipe 100 is attached to a central pivot. In those embodiments, the other end of the main pipe 100 is attached to a wheel assembly. Depending on the length of the main pipe 100, additional wheel assemblies 130 may be attached to the main pipe 100 along its span. In some lateral movement style embodiments, wheel assemblies 130 may be attached to both ends of the main pipe 100. Depending on the length of the main pipe 100, additional wheel assemblies 130 may be attached to the main pipe 100 along its span.

In some embodiments, the wheel assembly 130 comprises a triangular shaped structure attached to the main pipe 100 on one point and wheels on the other two points. Therefore, the two points attached to the wheels are coplanar and closer to the ground while the third point is elevated above approximately in between the two points attached to wheels. In some embodiments, this triangular shape is created by attaching three linear rods into a triangle. Therefore, the bottom rod is approximately parallel to the ground.

In some embodiments, the wheel assembly 130 includes an anchor 140 designed to negate irrigation drop during storms. In some embodiments, the anchor 140 is attached to the bottom rod, or the bottom portion, of the wheel assembly 130. In some embodiments, this anchor 140 is a bladder adapted to be filled with water delivered by the main pipe 100. The bladders may be filled when needed and then released and emptied by the operator. The weight of the bladder provides a breaking effect on the wheels and weighs down the assembly. Some embodiments of the present invention include a counterweight device use to help prevent rollover of a moving irrigation system.

In some embodiments a motor is attached to one or more of the wheel assemblies 130 in order to power the wheels and move the main pipe 100 across the field.

In some embodiments, one or more counterweights 150 are attached to the main pipe 100. The counterweights prevent twisting and rolling-over of the main pipe 100 and help stabilize it in high winds or other bad weather. In some embodiments of the present invention, elongated rods are attached to the main pipe 100 and extend outward parallel to the ground. In some embodiments, an additional weight is attached to the distal ends of each rod. In some embodiments, the rods are steel rods. In some embodiments, the rods are made of plastic, aluminum or another material. In some embodiments, the rods are 332″×1″ rods. In some embodiments, the weight attached to the rods is a 35-pound weight. In some embodiments, the rods are attached to the support structure of the main pipe 100 rather than the main pipe itself.

Some embodiments of the present invention include a shield 160 to help prevent deep rutting from ground saturation and the weight of the span wheels. The shield 160 is placed over the wheels of the wheel assembly 130. The shield 160 does not interfere with the rotation of the wheels but covers and protects them from water. In some embodiments, the shield 160 is sloped to deflect water.

In some embodiments of the present invention, the gooseneck assembly 200 is attachable to the nozzle 210 of the main pipe 100 and includes a flexible hose 220, a drop pipe 230, and a connector 240. The flexible hose 220 is connected on one end to the nozzle 210, and on the other end is connected to the drop pipe 230. In one embodiment, an additional connector 240 further secures the flexible hose 220 to the main pipe 100.

In one embodiment, the additional connector 240 is a strap attached around the circumference of the main pipe 100 and also attached to the flexible hose 220. In another embodiment, the additional connector 240 is a u-bolt. In another embodiment, the connector 240 is an adhesive. In another embodiment, the additional connector 240 is a type of tape. In another embodiment, the connector 240 is a rope, wire, string, or similar. It will be appreciated that other systems and methods for further securing the flexible hose 220 to the main pipe 100 may be used.

In some embodiments, hose barbs 250 a and 250 b are used to attach the flexible hose 220 to the nozzle 210 and the drop pipe 230. It will be appreciated that other types of connectors may be used to connect the flexible hose 220 to the nozzle 210 and drop pipe 230. In some embodiments, ferrules 260 a and 260 b are used to further secure the connections from the flexible hose 220 to both the nozzle 210 and the drop pipe 230.

In some embodiments, the internal cross-sectional area of the flexible hose 220 is greater than the cross-sectional area of the internal cross-sectional area of the nozzle 210. In some embodiments, the internal cross-sectional area of the flexible hose 220 is greater than the cross-sectional area of the internal cross-sectional area of the drop pipe 230. In some embodiments, the internal cross-sectional area of the nozzle 210 and drop pipe 230 are substantially similar and are less than the internal cross-sectional area of the flexible hose 220. The greater cross-sectional area of the flexible hose 220 reduces unwanted leaking or spillage.

In some embodiments wherein the cross-sections of the nozzle 210, flexible hose 220, and drop pipe 230 are all substantially circular, the diameter of the flexible hose 220 is one inch and the diameter of the nozzle 210 and drop pipe 230 is three-quarters of an inch. In some embodiments wherein the cross-sections of the nozzle 210, flexible hose 220, and drop pipe 230 are all substantially circular, the diameter of the nozzle 210 is approximately 33.3% (one-third) larger than the diameter of the nozzle 210 and drop pipe 230. In some embodiments, the internal cross-sectional area of the flexible hose 220 is approximately 50 to 100% greater than the internal diameter of the nozzle 210 and drop pipe 230. In some embodiments, the internal cross-sectional area of the flexible hose 220 is approximately 75 to 80% greater than the internal diameter of the nozzle 210 and drop pipe 230.

In some embodiments, the flexible hose is made of plastic. In some embodiments, the flexible hose 220 is made of HDPE. In some embodiments, the flexible hose 220 is made of HDPE plastic.

In some embodiments of the present invention, the gooseneck is structured to position a spraying head below the crop canopy. In some embodiments, the gooseneck of the present invention includes a connecting system to reduce stress on the threads going into the main pipe of the span. In some such embodiments the connecting system provides additional support of the gooseneck to the main pipe. In some such embodiments, the connecting system supports the drop and, in some embodiments, also allows the end user to move the drop to hit a specific row desired in the crops. In some embodiments, the gooseneck includes a coupling for tethering multiple goosenecks together along a span to create a stabilizing force along the span.

In some embodiments of the present invention, the spraying head 300 is attachable to the drop pipe 230 of the gooseneck assembly 200 and is generally spherical with a hollow center. In some embodiments, the hollow center fills up with water or another substance during irrigation to add weight to the spraying head. The added weight allows the spraying head to be pulled through the crop canopy by the irrigation system and reduces deflection of the spraying head due to gusts of wind.

In some embodiments the spraying head is an omni-directional spraying head. In some embodiments the spraying head is pre-drilled (or otherwise manufactured with orifices) to result in predetermined discharge parameters. In other embodiments, the spraying head is capable of being drilled by the end user to the specific discharge parameters desired by that end user.

In some embodiments, the spraying 300 is hung a distance above the ground. In some embodiments, the spraying head 300 is hung at 18 to 20 inches above the ground. In some embodiments, the spraying head 300 is hung so that it is drug along the ground. In some embodiments, the spraying head is hung so that it skims the crops.

In some embodiments, the spraying head is made of plastic. In some embodiments the spraying head is a High Density Polyethylene (HDPE) plastic.

zook@zook. In some embodiments, the gooseneck of the present invention is used in combination with the spraying head of the presentation invention. In other embodiments, the gooseneck of the present invention is used in combination with conventional spraying heads. In some embodiments, the gooseneck of the present invention is used in combination with conventional irrigation systems, whether lateral, pivot, or other systems. In some embodiments, the gooseneck of the present invention is used in chemigation, fertigation and/or planting applications.

In some embodiments of the present invention, additional elements may added between the drop pipe 230 and spraying head 300. In some embodiments, a hose may be added between the drop pipe 230 and spraying head 300. In some embodiments, a filter, valve, flow regulator, and/or pump may be added between the drop pipe 230 and spraying head 300.

In some embodiments of the present invention, additional elements may added between the flexible hose 220 and the drop pipe 230. In some embodiments, an additional hose may be added between the flexible hose 220 and the drop pipe 230. In some embodiments, a filter, valve, flow regulator, and/or pump may be added between the flexible hose 220 and the drop pipe 230. In some embodiments, the drop pipe 230 may be replaced altogether with a hose.

In some embodiments of the present invention, the goosenecks 200 coming from the main pipe 100 alternating perpendicular directions. In other words, if looking directly down the main pipe 100, the goosenecks alternate coming up and off the left side to coming up and off the right side of the main pipe 100. In this embodiment, the spraying heads 300—will be in two separate rows, with every other spraying head being in either the left or right row. In some embodiments, the spraying heads 300 are then tethered together using rope, chain, string, or by some other means. The tether begins with the spraying head 300 nearest the distal end of the main pipe 100 and continues to the next spraying head 300 along the span of the main pipe 100 until reaching the spraying head 300 nearest the proximal end of the main pipe 100. The tether will appear to be in a zig-zag because each spraying head 300 is in an alternate row.

Some embodiments of the present invention include a system to plant cover crops.

It will be appreciated that various embodiments of components and/or combinations of the present invention are capable of use in irrigation applications, as well as in chemigation, fertigation and/or planting applications.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

What is claimed is:

1. A gooseneck assembly for connecting to a nozzle of a span pipe, the assembly comprising:
a flexible hose, including a hollow elongated body, a proximal end, and a distal end, wherein said proximal end is capable of being connected to the nozzle of the span pipe;
a drop pipe, including a first end and second end, wherein said first end is capable of being connected to the distal end of said flexible hose; and
a connector capable of securing said body of said flexible hose to the span pipe.

2. The assembly of claim 1,
wherein said proximal end of said flexible hose is connected to the nozzle of the span pipe with a first hose barb; and
wherein said first end of said drop pipe is connected to said distal end of said flexible hose with a second hose barb.

3. The assembly of claim 2, wherein the internal cross-sectional area of said body of said flexible hose is greater than the internal cross-sectional area of the nozzle of the span pipe and the internal cross-sectional area of said drop pipe.

4. The assembly of claim 3, wherein the internal cross-sectional area of the nozzle and the internal cross-sectional area of said drop pipe are substantially equal.

5. The assembly of claim 2, further comprising a first ferrule used in cooperation with said first hose barb and a second ferrule used in cooperation with said second hose barb.

6. The assembly of claim 1, further comprising a spraying head connected to said second end of said drop pipe.

7. The assembly of claim 6, wherein said spraying head is spherical shaped and hollow.

8. The assembly of claim 7, wherein said spraying head further includes a plurality of outlets.

9. The assembly of claim 6, further comprising a second flexible hose between said spraying head and said second end of said drop pipe.

10. The assembly of claim 1, wherein said connector is a strap.

11. A gooseneck assembly for connecting to a nozzle of a span pipe, the assembly comprising:
a flexible hose, including a hollow elongated body with a substantially circular cross-section, a proximal end, and a distal end, wherein said proximal end is capable of being connected to the nozzle of the span pipe; and
a drop pipe, including a substantially circular cross-section, a first end, and second end, wherein said first end is capable of being connected to the distal end of said flexible hose.

12. The assembly of claim 11,
wherein said proximal end of said flexible hose is connected to the nozzle of the span pipe with a first hose barb; and
wherein said first end of said drop pipe is connected to said distal end of said flexible hose with a second hose barb.

13. The assembly of claim 12, wherein the diameter of said body of said flexible hose is greater than the diameter of the nozzle of the span pipe and the radius of said drop pipe.

14. The assembly of claim 13, wherein the diameter of the nozzle and the diameter of said drop pipe are substantially equal.

15. The assembly of claim 11, further comprising a spraying head connected to said second end of said drop pipe.

16. The assembly of claim 15, wherein said spraying head is spherical shaped and hollow.

17. The assembly of claim 16, wherein said spraying head further includes a plurality of outlets.

18. An irrigation system, the system comprising:
a main pipe including a hollow interior and at least one nozzle;
at least one flexible hose, including an elongated body, a proximal end, and a distal end, wherein said proximal end of each flexible hose is connected to a nozzle of said span pipe;
at least one drop pipe, including a first end and second end, wherein said first end of each drop pipe is connected to a distal end of one or more said flexible hoses; and
at least one connector capable of securing said body of each flexible hose to the span pipe.

19. The assembly of claim 18,
wherein each proximal end of a flexible hose is connected to a nozzle of the span pipe with a first hose barb; and
wherein each first end of a drop pipe is connected to a distal end of a flexible hose with a second hose barb.

20. The assembly of claim 19, wherein the internal cross-sectional area of each body of said flexible hose is greater than the internal cross-sectional area of each nozzle of the span pipe and the internal cross-sectional area of each drop pipe.
